(19) United States
(12) Patent Application Publication
(10) Pub. No.: US 2026/0210290 A1
(43) Pub. Date: Jul. 23, 2026

(54) HEAT EXCHANGE SYSTEM FOR AN AIRCRAFT TURBINE ENGINE

(71) Applicant: SAFRAN, Paris (FR)

(72) Inventors: Samer MAALOUF, MOISSY-CRAMAYEL (FR); Ephraïm TOUBIANA, MOISSY-CRAMAYEL (FR)

(73) Assignee: SAFRAN, Paris (FR)

(21) Appl. No.: 19/157,936

(22) PCT Filed: Feb. 16, 2024
(86) PCT No.: PCT/FR2024/050207

§ 371 Date: Aug. 19, 2025

(30) Foreign Application Priority Data
Feb. 23, 2023 (FR) 2301671

(51) Int. Cl. F02C 7/14; F02K 3/06

(52) U.S. Cl. CPC F02C 7/14; F02K 3/06; F05D 2220/323; F05D 2260/213

(57) ABSTRACT

A heat exchange system, in particular for an aircraft turbine engine, includes an outer annular wall and an inner annular wall. A first annular heat exchange device is carried by one of the walls and includes a heat exchange matrix positioned between this wall and a cover. The system further includes a second annular heat exchange device which has a heat exchange matrix axially spaced apart from the heat exchange matrix of the first device and which is positioned between the cover of the first device and the opposite wall or another cover of the second device.

### FIELD OF THE INVENTION

The present invention relates to the general field of cooling, and its application in particular in the field of aeronautics. It is aimed in particular at a heat exchange system, especially for a turbine engine, in particular an aircraft.

### TECHNICAL BACKGROUND

The technical background comprises in particular the documents US-B1-6,68,915, EP-A1-3,196,443 and WO-A1-2022/064136.

A turbine engine, in particular for an aircraft, comprises various members and/or items of equipment that need to be lubricated and/or cooled, such as rolling bearings and gears. The heat released by these components, which can be very high depending on the power of the member and/or the item of equipment, is transported by a fluid and evacuated towards cold sources available in the aircraft.

It is known to equip the turbine engine with one or more heat exchange systems to carry out the heat exchange between the fluid (typically oil) and the cold source (air, fuel, etc.). There are even different types of heat exchange systems, such as for example the fuel/oil heat exchangers, generally known by the acronym FCOC (Fuel Cooled Oil Cooler) and the air/oil heat exchangers, known by the acronym ACOC (Air-Cooled Oil Cooler).

The FCOC heat exchangers have a dual function of heating the fuel before the combustion in the combustion chamber of the turbine engine and cooling the oil heated by the thermal dissipations of the turbine engine. However, the heat exchangers FCOC are not sufficient to absorb all the thermal dissipations because the temperature of the fuel is limited for safety reasons.

The additional cooling is obtained by the heat exchangers ACOC, in particular those of the surface type referred by the acronym SACOC. The surface heat exchangers are usually arranged in the secondary duct of the turbine engine and use the secondary air flow to cool the oil circulating in the turbine engine. These heat exchangers are in the form of a metallic surface part allowing the passage of oil in machined channels. The secondary air flow is guided along a heat exchange matrix carried by this surface part, the purpose of which is to increase the contact surface with the secondary air flow and extract heat. However, the disadvantage of the SACOC heat exchangers is that they create additional pressure losses in the relevant secondary duct, since they disturb the air flow, which has an impact on the performance of the turbine engine as well as on the specific fuel consumption.

The Applicant has already proposed a solution to this problem in the documents FR-A1-3 096 409 and FR-A 1-3 096 444.

In addition, the cooling requirements of the lubricating fluid are increasing due to the higher rotational speeds and the power requirements to meet the specification trends on the turbine engines.

In fact, the ACOC heat exchangers are increasingly being used in the next generation of the engines due to the significant increase in heat dissipation, mainly due to:
the engines of the future will be larger, increasing the need for lubrication and oil cooling,
the presence of a speed reduction gear in the new motor architectures, this reduction gear transmitting very high mechanical power and requiring to be lubricated and cooled by oil, and
the addition of electric machines on board an engine for hybridization, these machines needing to be lubricated and cooled with oil.

The engine may comprise several oil circuits, each with a specific function, for example a first circuit for cooling the oil dedicated to the lubrication and cooling of the engine, a second for the lubrication and cooling of the motor reduction gear, a third for the cooling of the machines, etc. The temperature and oil flow rate must be controlled according to the corresponding circuit. For example, the oil used to lubricate and cool electrical machines has a different temperature range to that used for engine cooling. Thus, the ACOC is preferably divided into several exchangers, each exchanger being dedicated to a given oil circuit. These different heat exchangers are generally distributed around the longitudinal axis of the engine.

The growing need for cooling has a direct impact on the dimensions of ACOCs. One must therefore expect to have large exchangers to be able to evacuate the calories from the oil. In order to evacuate the oil calories, the ACOCs could occupy all the available space in a duct, and thus extend all around the duct and over the entire height or radial dimension of the duct, in order to have the necessary air flow rate to evacuate the calories at the dimensioning point, which generally occurs during the take-off phase in the case of an extreme hot day.

However, the fact that the ACOC exchangers occupy the entire radial height of the duct prevents control of the flow through the exchanger using the solution described in the documents FR-A 1-3 096 409 and FR-A 1-3 096 444.

As a result, all the airflow passes through the ACOCs and each of the ACOCs operates with sub-optimal aerothermal performance. This results in a high pressure drop on the air side, leading to inefficient heat exchangers.

The aim of the present invention is to propose an improvement to existing technologies that optimizes the efficiency of heat exchange while avoiding pressure losses and disturbing the gas flow as little as possible.

### SUMMARY OF THE INVENTION

The invention thus proposes a heat exchange system, in particular for an aircraft turbine engine, this system comprising:
two annular walls, external and internal respectively, which extend around each other and around a same axis, and which are configured to define between them a flow duct for a gas flow,
a first annular heat exchange device which extends around the axis and is carried by one of said walls, and which is located in the duct, this first device comprising a heat exchange matrix interposed between this wall and a cowl which has a predetermined diameter D1 measured at the axial center of the heat exchange matrix of the first device, characterized in that it further comprises:
a second annular heat exchange device which extends around the axis and is located in the duct, this second device comprising a heat exchange matrix which is axially spaced from the heat exchange matrix of the first device and which is interposed between the cowl of the first device and the opposite wall or another cowl of the second device, the cowl of the first device having a predetermined diameter D2 measured at the axial center of the heat exchange matrix of the second device, and in that:
D2 is greater than D1 when the first device is carried by the external wall, or
D2 is less than D1 when the first device is carried by the internal wall.

The present invention thus proposes to combine at least two heat exchange devices in the duct and to position these devices so that they are, on the one hand, axially offset from each other and, on the other hand, staggered in relation to each other.

The axial offset of the devices is due to the fact that the heat exchange matrices of the devices are axially spaced from each other. The heat exchange matrix of the first device is located upstream or downstream with respect to the heat exchange matrix of the second device.

In this application, the expressions upstream and downstream refer to the flow of air or gases in the duct during normal operation of the turbine engine.

In the present application, a heat exchange matrix may comprise fins and/or plates and/or tubes. A matrix may be layered and comprise, for example, a stack of several layers, each of the layers comprising fins, or at least one plate or at least one tube. The fins are designed to be swept by a gas flow, and the plates or tubes are traversed by an oil circuit, for example, or comprise such an oil circuit.

The staggering of the devices results from the fact that the devices share a common cowl, this cowl being advantageously shaped so that part of the heat exchange matrix of the second device is axially aligned with a part of the heat exchange matrix of the first device. As well as being staggered, the devices can therefore overlap axially.

The heat exchange system may comprise one or more of the following characteristics, considered independently or in combination with each other:
the cowl of the first device comprises several successive axial sections along the axis:
   an upstream end section which is located upstream of the heat exchange matrix of the second device, a section which extends at the periphery of the heat exchange matrix of the second device, an intermediate section which extends axially between the heat exchange matrix of the second device and the heat exchange matrix of the first device, a section which extends at the periphery of the heat exchange matrix of the first device, and a downstream end section which is located downstream of the heat exchange matrix of the first device, or
   an upstream end section extending upstream of the heat exchange matrix of the first device, a section extending at the periphery of the heat exchange matrix of the first device, an intermediate section which extends axially between the heat exchange matrix of the first device and the heat exchange matrix of the second device, a section which extends at the periphery of the heat exchange matrix of the second device, and a downstream end section which is located downstream of the heat exchange matrix of the second device;
the cowl of the second device comprises an upstream end section located upstream of the heat exchange matrix of this second device, a section located at the periphery of the heat exchange matrix of this second device, and a downstream end section located downstream of the heat exchange matrix of this second device:
the cowl of the second device has a predetermined diameter D3 measured at the axial center of the heat exchange matrix of the second device, and in that D3 is less than or greater than D1;
D3 is greater than D1 when the first device is carried by the external wall, or D3 is less than D1 when the first device is carried by the internal wall;
   this accentuates the staggering of the devices and the axial alignment of their heat exchange matrices;—the cowl of the second device has an upstream free end which is located upstream of an upstream free end of the cowl of the first device, or which is located between upstream and downstream ends of the intermediate section
the system further comprises:
   a third annular heat exchange device which extends around the axis and is located in the duct, this third device comprising heat exchange matrix which is axially spaced from the heat exchange matrix of the first and second devices and which is interposed between the cowl of the second device and the other of the walls or a further cowl of the third device, the cowl of the second device having a predetermined diameter D3 measured at the axial center of the heat exchange matrix of the second device, and a predetermined diameter D4 measured at the axial center of the heat exchange matrix of the third device,
and in that:
   D4 is greater than D3 when the first device is carried by the external wall, or
   D4 is less than D3 when the first device is carried by the internal wall;
the cowl of the third device comprises an upstream end section located upstream of the heat exchange matrix of this third device, a section located at the periphery of the heat exchange matrix of this third device, and a downstream end section located downstream of the heat exchange matrix of this third device;
said or each upstream end section forms a divergent, and said or each downstream end section forms a convergent;
the end sections have a frustoconical or rounded shape;
the heat exchange matrix of the first device has a radial height or dimension greater than or equal to that of the heat exchange matrix of the second device;
the sum of the heights or radial dimensions of the heat exchange matrix of the first and second devices is less than the height or radial dimension of the duct measured at the level of these devices;
the sum of the heights or radial dimensions of the heat exchange matrix of the first and second devices is greater than the height or radial dimension of the duct measured at these devices;
each of the external and internal walls carries a first device of the aforementioned type, which is associated with a second device of the aforementioned type or even with a third device of the aforementioned type;
each of the devices is of the ACOC or SACOC type;
each divergent and each convergent has a truncated cone or rounded shape; the rounded shape improves the aerodynamics of the flow bypassing the device, thereby reducing the pressure drops due to the installation of this assembly. These shapes can be obtained by additive manufacturing, for example;
said or each cowl is independent of the walls of the duct, and is therefore not connected to these walls;
the first heat exchange device is a surface heat exchange device, and/or the second heat exchange device is of the surface type, and/or the third heat exchange device is of the surface type;
said or each heat exchange device is of the SACOC or ACOC type;
said or each cowl is at a distance from the walls of the duct so that a part of the gas flow flowing in the duct can bypass said or each heat exchange device.

The invention also relates to a turbine engine or electronic device comprising at least one heat exchange system as mentioned above. The present invention can be used to cool an appliance.

### BRIEF DESCRIPTION OF THE FIGURES

The invention will be better understood, and other purposes, details, characteristics, and advantages thereof will become clearer upon reading the detailed explanatory description that follows, of embodiments of the invention given as purely illustrative and non-limiting examples, with reference to the accompanying schematic drawings in which:

FIG. 1 is a schematic half-view in axial section of an example of a turbine engine to which the invention applies;

FIG. 2 is a schematic cross-sectional view of a heat exchange system;

FIG. 3 shows a very schematic axial section of the system shown in FIG. 2;

FIG. 4 is another very schematic view of a system similar to the one shown in FIG. 3;

FIG. 5 is a partial schematic perspective view of a heat exchange device;

FIGS. 6a and 6b are highly schematic cross-sectional views of heat exchange systems each comprising a sectorized heat exchange device;

FIG. 7 is a very schematic axial cross-sectional view of the system in FIG. 6a;

FIG. 8 is a very schematic axial cross-sectional view of a heat exchange system according to a first embodiment of the invention;

FIG. 9 is a very schematic axial cross-sectional view of a heat exchange system according to a second embodiment of the invention;

FIG. 10 is a very schematic axial cross-sectional view of a heat exchange system according to a third embodiment of the invention;

FIG. 11 is a very schematic axial sectional view of a heat exchange system according to a fourth embodiment of the invention;

FIG. 12 is a very schematic axial sectional view of a heat exchange system according to a fifth embodiment of the invention;

FIG. 13 is a very schematic axial sectional view of a heat exchange system according to a sixth embodiment of the invention;

FIG. 14 is a very schematic axial sectional view of a heat exchange system according to a seventh embodiment of the invention;

FIG. 15 is a very schematic axial sectional view of a heat exchange system according to an eighth embodiment of the invention.

### DETAILED DESCRIPTION OF THE INVENTION

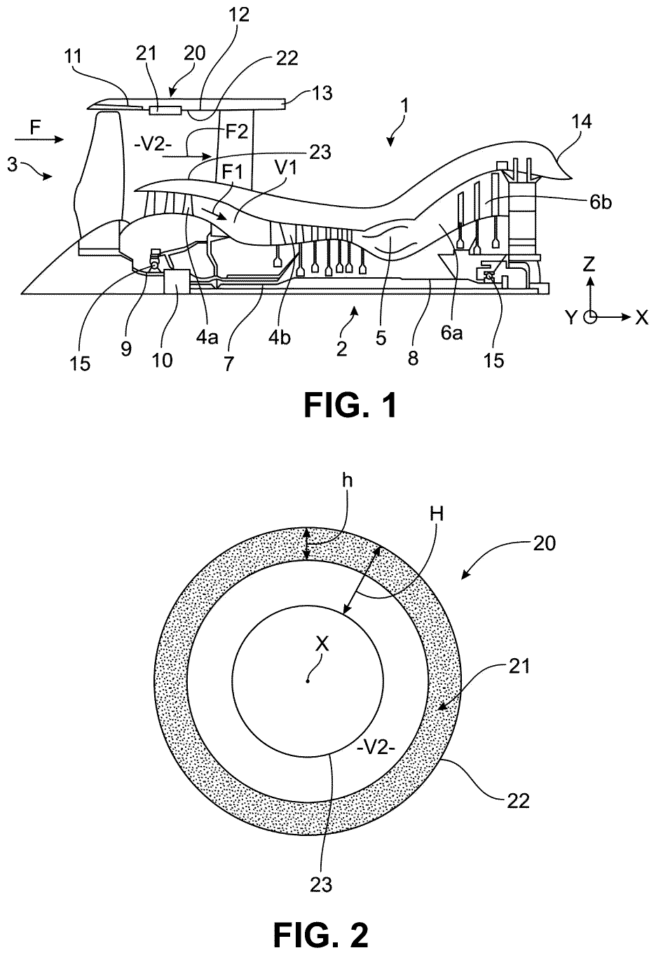

FIG. 1 shows an axial cross-section of a turbine engine of longitudinal axis X to which the invention applies. The turbine engine shown is a turbofan 1 designed to be mounted on an aircraft. Of course, the invention is not limited to this type of turbine engine.

This double-flow turbine engine 1 generally comprises a gas generator 2 upstream of which is mounted a fan or fan module 3.

In the present invention, the terms “upstream” and “downstream” are defined in relation to the flow of gases in the turbine engine 1 and here along the longitudinal axis X.

The gas generator 2 comprises a gas compressor assembly (here comprising a low-pressure compressor 4a and a high-pressure compressor 4b), a combustion chamber 5 and a turbine assembly (here comprising a high-pressure turbine 6a and a low-pressure turbine 6b).

Typically, the turbine engine 1 comprises a low-pressure shaft 7 which connects the low-pressure compressor 4a and the low-pressure turbine 6a to form a low-pressure body, and a high-pressure shaft 8 which connects the high-pressure compressor 4b and the high-pressure turbine 6b to form a high-pressure body.

The low-pressure shaft 7, centered on the longitudinal axis X, drives a fan shaft 9 via a speed reduction gear 10. Rotational guide bearings 15 also allow the low-pressure shaft 7 to be guided in rotation relative to a fixed structure or stator of the turbine engine. The high-pressure shaft 8 is also guided in rotation by guide bearings (not shown).

The fan 3 is ducted in a fan casing 11 carried by a nacelle 12 and generates a primary air flow F1 which circulates through the gas generator 2 in a primary duct V1, and a secondary air flow F2 which circulates in a secondary duct V2 around the gas generator 2.

The secondary air flow F2 is ejected by a secondary nozzle 13 terminating the nacelle, while the primary air flow F1 is ejected outside the turbine engine 1 via an ejection nozzle 14 located downstream of the gas generator 2.

In the following description, the fan casing 11 and the nacelle 12 are considered as one single piece.

The guide bearings 15 and the speed reduction gear 10 in this example configuration of the turbine engine 1 must be lubricated and/or cooled to ensure the performance of the turbine engine 1. The power generated by these is dissipated in a fluid from a fluid supply source installed in the turbine engine 1, which is used to lubricate and/or cool various members and/or equipment in the turbine engine 1. Of course, other equipment in turbine engine 1 generates a lot of heat that needs to be extracted from its environment.

To this end, the turbine engine 1 comprises a heat exchange system 20 that allows the fluid configured to lubricate and/or cool these members and/or items of equipment to be cooled. In this example, the fluid is an oil and the cold source for cooling the oil is a gas flow circulating in the turbine engine, in particular the secondary air flow F2.

In the context of the present invention, a heat exchange system 20 means a system comprising:
two annular walls, external and internal respectively, which extend around each other and around the same axis, and which are configured to define between them a flow duct for a gas flow, and
at least one annular heat exchange device located in this duct.

In FIG. 1, for example, the heat exchange system 20 of the turbine engine 1 comprises an external wall 22 formed by the fan casing 11 and/or the nacelle 12, an internal wall 23 formed by a casing of the gas generator 2, and a heat exchange device 21 which is carried here by the external wall 22 and located in the duct V2.

The heat exchange device 21 is for example of the surface type (for example of the SACOC type) and preferably of the air/oil type.

The device 21 comprises an oil circuit and a heat exchange matrix located in the duct V2 and configured to be swept by said gas flow F2. As mentioned above, the heat exchange matrix may comprise fins and/or plates and/or tubes. A matrix may be staggered and comprise, for example, a stack of several layers, each of the layers comprising fins, at least one plate or at least one tube. The fins are designed to be swept by a gas flow, and the plates or tubes are traversed by an oil circuit, for example, or comprise such an oil circuit.

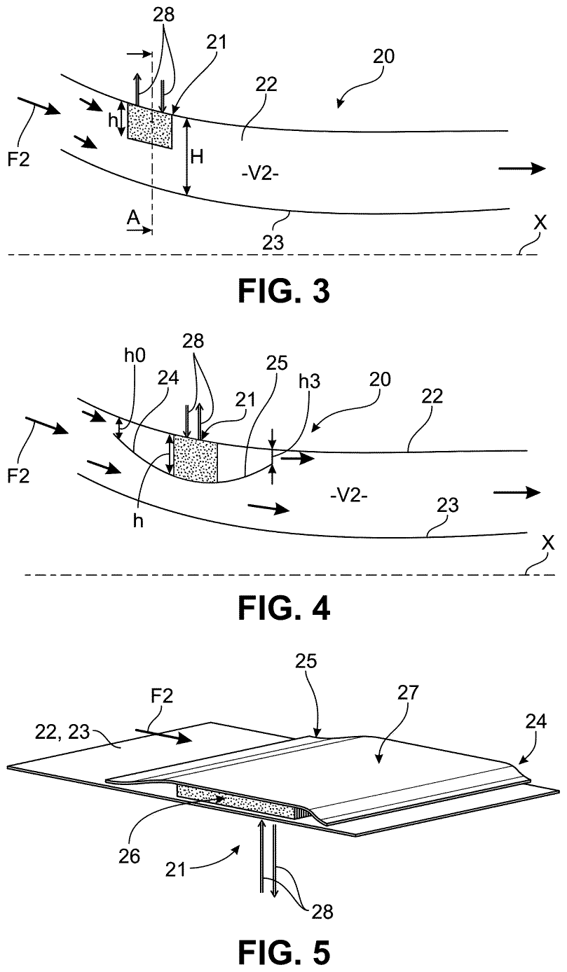

FIGS. 2 and 3 schematically show a heat exchange system 20 of this type. It can be seen that the heat exchange device 21 of this system 20 is annular and extends continuously over 360° around the axis X.

We can also see that it occupies only part of the height H of the duct V2. The device 21 has a height h or radial dimension which represents only part of the height H or radial dimension of the duct V2. These heights H, h are measured in a radial direction with respect to the axis X, in an area of the duct V2 wherein this device 21 is located. The height H of the duct V2 is likely to change along the axis X.

One of the problems observed in a device 21 of this type is the disturbances and pressure drops generated in the gas flow F2, which has the effect of increasing the specific fuel consumption of the turbine engine 1. Hence the importance of optimizing the aerothermal performance of this system 20.

In the aforementioned documents, the Applicant proposed a solution for optimizing the integration of this type of device 21 in a duct, which is illustrated in FIG. 4. The idea is to slow down the speed of the gas flow through the device 21. The flow of gas through the device 21 is highly turbulent. Slowing down the speed of flow of the air flow entering the device 21 allows its aerothermal performance to be optimized, thereby minimizing the pressure drop for a given heat dissipation. The control of the flow through the device 21 can be achieved by combining the device 21 with a divergent 24 at the inlet and a convergent 25. The divergent 24 upstream of the device 21 is configured to compress and slow down the gas flow entering the device 21, and the convergent 25 downstream of the device 21 is configured to accelerate and expand the gas flow leaving the device.

At the inlet of the device 21, the deceleration factor is inversely proportional to the ratio of the heights h/h0, h being the aforementioned height and h0 being the height at the inlet of the divergent 24. Note that the slower the flow, the lower the pressure drop generated by the device 21. At the outlet of the device 21, the acceleration factor is inversely proportional to the ratio of heights h/h3, h3 being the height at the outlet of the convergent 25.

FIG. 5 shows a perspective view of part of a heat exchange device 21. This shows the heat exchange matrix 26, which is sandwiched between a cowl 27 and the wall 22, 23 carrying the device 21. The convergent 25 and the divergent 24 can be formed by ends of the cowl 26, as in the example shown.

In FIG. 5 and the other figures, arrows are used to schematically represent the oil circuit 28.

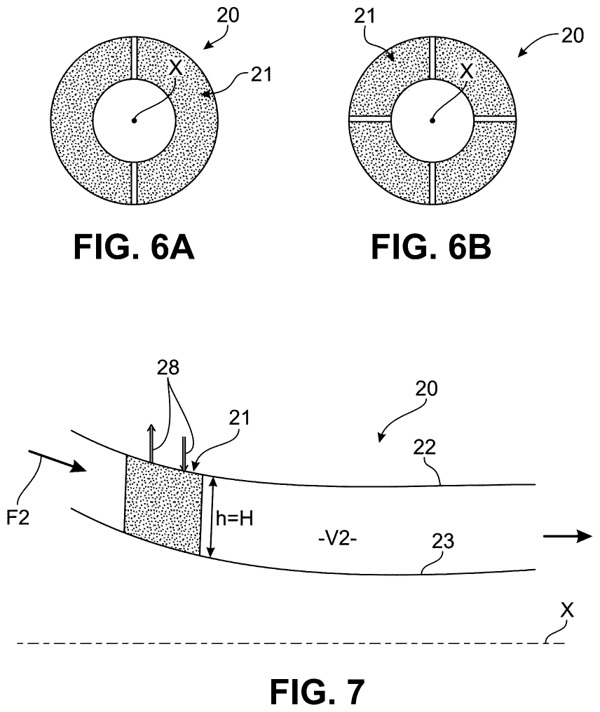

FIGS. 6a and 6b schematically show alternative versions of heat exchange systems 20.

In the case of FIG. 6a, the system 20 comprises an annular heat exchange device 21 which is sectorized and comprises two sectors each having an angular extent of approximately 180°.

In the case of FIG. 6b, the system 20 comprises an annular heat exchange device 21 which is sectorized and comprises four sectors each having an angular extent of approximately 90°.

In FIGS. 6 a-6b, the heat exchange device 21 extends over the entire height H of the duct and is connected to the two walls 22, 23. The height h of the device 21 is then equal to the height H of the duct (FIG. 7).

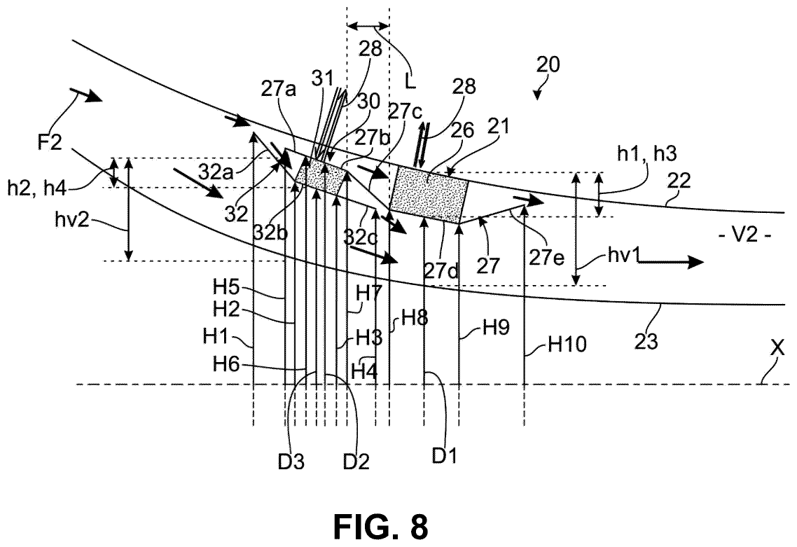

The present invention is an improvement on this technology and offers a number of embodiments, which are illustrated in FIG. 8 and following.

One of the characteristics of the invention is that the heat exchange system comprises at least two annular heat exchange devices and that these devices are arranged so as to be staggered and so that their heat exchange matrices are axially spaced from one another.

In the first embodiment of the invention shown in FIG. 8, the heat exchange system 20 comprises:
two annular walls, external 22 and internal 23 respectively, which extend one around the other and around the same axis X, and which are configured to define between them a flow duct V2 for a gas flow, such as a secondary flow F2,
a first annular heat exchange device 21 which extends around the axis X and is carried by one of the walls, here the external wall 22, and which is located in the duct V2, this first device 21 comprising a heat exchange matrix 26 interposed between this wall 22 and a cowl 27 which has a predetermined diameter D1 measured at the axial center of the heat exchange matrix 26 of this first device 21, and
a second annular heat exchange device 30 which extends around the axis X and is located in the duct V2, this second device 30 comprising a heat exchange matrix 31 which is axially spaced from the heat exchange matrix 26 of the first device 21 and which is interposed between the cowl 27 of the first device 21 and another cowl 32 of the second device 30, the cowl 31 of the first device 21 having a predetermined diameter D2 measured at the axial center of the heat exchange matrix 31 of the second device 30.

FIG. 8 shows that the heat exchange matrices 26, 31 of the devices 21, 30 are axially spaced apart in the duct V2 by an axial distance L. In the example shown, the device 21 located on the external wall 22 is located downstream of the device 30.

In the embodiment shown in FIG. 8, D2 is larger than D1, i.e., an external peripheral portion of the heat exchange matrix 31 of the second device 30 is aligned in the axial direction with an internal peripheral portion of the heat exchange matrix 26 of the first device 21.

These devices 21, 30 are preferably of the air-oil type and for example of the surface type and each comprise an oil circuit 28 in addition to the heat exchange matrix 26, 31 which are located in the duct V2 and configured to be swept by the gas flow F2, as mentioned above. The devices 21,30 thus have the cowl 27 in common,

The heat exchange matrix 26 of the device 21 is covered by the annular cowl 27 which extends axially, here upstream, to form the external cowl of the heat exchange matrix 31 of the device 30. This cowl 27 is thus located at the internal periphery of the heat exchange matrix 26 of the device 21 and at the external periphery of the heat exchange matrix 31 of the device 30. The heat exchange matrix 31 of the device 30 is also connected to the other cowl 32 which is therefore located at the internal periphery of this heat exchange matrix 31. The cowl 27 of the first device 21 comprises several successive axial sections along the axis X, namely:
an upstream end section 27a that is located upstream of the heat exchange matrix 31 of the second device 30,
a section 27b which extends to the external periphery of the heat exchange matrix 31 of the second device 30,
an intermediate section 27c which extends axially between the heat exchange matrix 31 of the second device 30 and the heat exchange matrix 26 of the first device 21,
a section 27d which extends to the internal periphery of the heat exchange matrix 26 of the first device 21, and
a downstream end section 27e located downstream of the heat exchange matrix 26 of the first device 21.

The cowl 32 of the second device 30 comprises:
an upstream end section 32a located upstream of the heat exchange matrix 31 of this second device 30,
a section 32b located at the internal periphery of the heat exchange matrix 31 of this second device 30, and
a downstream end section 32c located downstream of the heat exchange matrix 31 of this second device 30.

It can be seen that each of the upstream end sections 27a, 32a forms a divergent, and that each of the downstream end sections 27e, 32c forms a convergent.

In the example shown, the end sections 27a, 27e, 32a, 32c each have a frustoconical shape.

The cowl 32 of the second device 30 has a predetermined diameter D3 measured at the axial center of the heat exchange matrix 31 of the second device 30. In the example shown, D3 is greater than D1. D3 is also lower than D2. In FIG. 8:
H1 represents the diameter at the free upstream end of the cowl 32 or of the upstream end section 32a of this cowl 32,
H2 represents the diameter at the downstream end of the upstream end section 32a of this cowl 32,
H3 represents the diameter at the upstream end of the downstream end section 32c of this cowl 32,
H4 represents the diameter at the free downstream end of the cowl 32 or of the downstream end section 32c of this cowl 32,
H5 represents the diameter at the free upstream end of the cowl 27 or of the upstream end section 27a of this cowl 27,
H6 represents the diameter at the downstream end of the upstream end section 27a of this cowl 27,
H7 represents the diameter at the upstream end of the intermediate section 27c,
H8 represents the diameter at the downstream end of the intermediate section 27c,
H9 represents the diameter at the upstream end of the downstream end section 27e of this cowl 27, and
H10 represents the diameter at the free downstream end of the cowl 27 or of the section of the downstream end 27e of this cowl 27.

These diameters are measured in relation to the axis X.

In the example shown:
H1 is greater than or equal to H2, H5 and H6 in particular, H2 could also be the maximum diameter of the system 20,
H5 is greater than H2 and H6 in particular, H2 could also be the maximum diameter of the cowl 27,
H7 is superior to H8, H3 and H4 in particular,
H2 and H3 are higher than H8 and H9.

Each of the devices 21, 30 may comprise a single heat exchanger, or may be sectorized and comprise two or more heat exchangers distributed around the axis X, as described above.

In the example shown, the device 21 located on the right of the drawing occupies a height h1 in the duct of between 20 and 50% of the height hv1 of this duct.

The device 30 located on the left of the drawing occupies a height H2 in the duct of between 10 and 30% of the height hv2.

The heat exchange matrix 26 of the first device 21 has a height h3 or radial dimension greater than or equal to that h4 of the heat exchange matrix 31 of the second device 30. The sum of the heights h3, h4 or radial dimensions of the heat exchange matrices 26, 31 of the first and second devices 21, 30 is less than the height hv1, hv2 or radial dimension of the duct V2 measured at these devices 21, 30.

It is understood that an external peripheral part of the air flow F2 (for example between 5 and 50% of the flow) flowing in the duct will be used in the devices 21, 30 and that the rest of this flow will bypass the devices 21, 30. The air used in the devices will divide into a first, inner peripheral part (representing for example 2.5 to 25% of the flow), which will penetrate the device 30, and the remainder, the external peripheral part (representing for example 2.5 to 25% of the flow rate), which will penetrate the device 21.

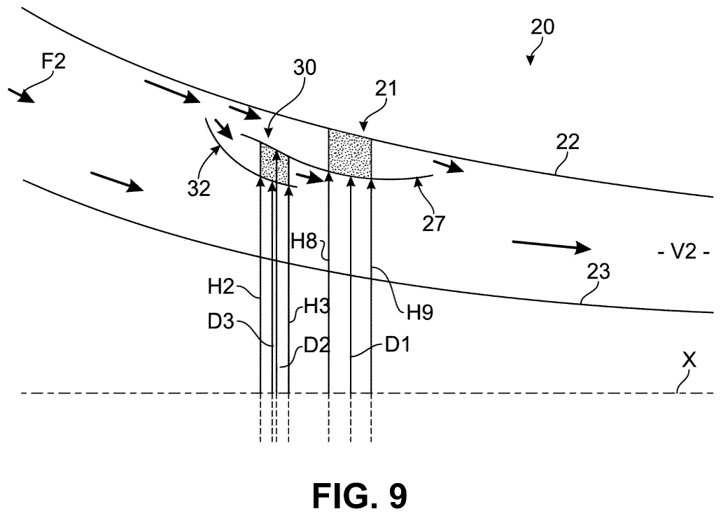

The second embodiment shown in FIG. 9 differs from the first in that the cowls 27, 32 each have a curved or undulating shape.

Furthermore, in the example shown, D3 is less than D1. In addition, H2 and H3 are less than H8 and H9.

In the example shown, it can be seen that the section of the cowl 27 which extends around the periphery of the heat exchange matrix of the second device 30 has a recess facing the internal wall 23. The cross-section of the cowl 27 is a generally curved or wave shape. It can also be seen that the cowl 32 is essentially curved on the side of the internal wall 23. The system shown in FIG. 9 operates in a similar way to FIG. 8.

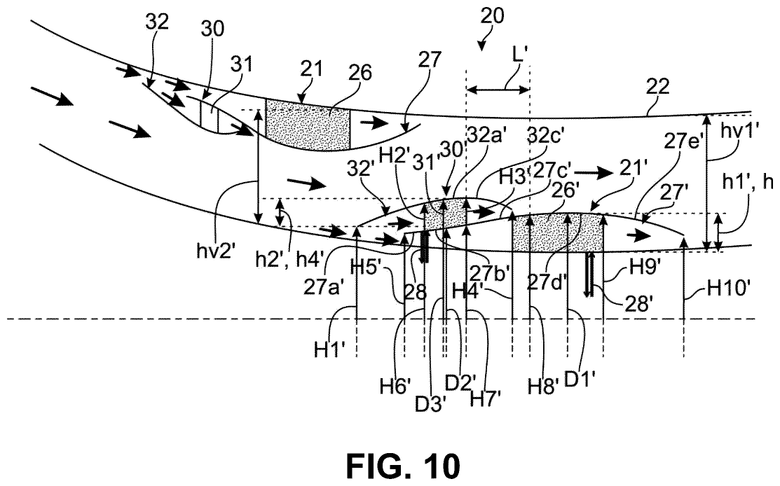

The third embodiment shown in FIG. 10 differs from the second embodiment in that, in addition to the devices 21, 30 located on the level of the external wall 22, similar devices 21′, 30′ are located on the internal wall 23.

The heat exchange system 20 therefore also comprises devices 21, 30:
another first annular heat exchange device 21′ which extends around the axis X and is carried by the internal wall 23, and which is located in the duct V2, this first device 21 comprising an interposed heat exchange matrix 26′ between this wall 23 and a cowl 27′ which has a predetermined diameter D1 measured at the axial center of the heat exchange matrix 27 of this first device 21′ , and
another second annular heat exchange device 30′ which extends around the axis X and is located in the duct V2, this second device 30′ comprising a heat exchange matrix 31′ which is axially spaced from the heat exchange matrix 26′ of the first device 21′ and which is interposed between the cowl 27′ of the first device 21′ and another cowl 32′ of the second device 30′, the cowl 27′ of the first device 21′ having a predetermined diameter D2′ measured at the axial center of the heat exchange matrix 31′ of the second device 30′.

FIG. 10 shows that the heat exchange matrices 27′, 31′ of the devices 21′, 30′ are axially spaced apart in the duct V2 by an axial distance L′. In the example shown, the device 21′ on the internal wall 23 is located downstream of the device 30′.

In this embodiment, D2′ is less than D1, i.e. an internal peripheral part of the heat exchange matrix 31′ of the second device 30′ is aligned in the axial direction with an external peripheral part of the heat exchange matrix 26′ of the first device 21′.

These devices 21′, 30′ are preferably of the air-oil type and each comprise an oil circuit 28′ in addition to the heat exchange matrix 26′, 31′ which is located in the duct V2 and configured to be swept by the gas flow F2, as mentioned above.

The devices 21′, 30′ have the cowl 27′ in common.

The heat exchange matrix 26′ of the device 21′ is covered by the annular cowl 27′ which extends axially, here upstream, to form an external cowl for the heat exchange matrix 31′ of the device 30′. This cowl 27′ is thus located at the external periphery of the heat exchange matrix 26′ of the device 21′ and at the internal periphery of the heat exchange matrix 31′ of the device 30′ . The heat exchange matrix 31′ of the device 30′ is also connected to the other cowl 32′, which is therefore located at the external periphery of these surface exchangers 31′.

The cowl 27′ of the first device 21′ comprises several successive axial sections along the axis, namely:
an upstream end section 27a′ located upstream of the heat exchange matrix 31 of the second device 30′,
a section 27b′ which extends to the internal periphery of the heat exchange matrix 31′ of the second device 30′,
an intermediate section 27c′ which extends axially between the exchange matrix 31′ of the second device 30′ and the heat exchange matrix 26′ of the first device 21′,
a section 27d′ which extends to the external periphery of the heat exchange matrix 26′ of the first device 21′, and
a downstream end section 27e′ located downstream of the heat exchange matrix 26′ of the first device 21′,

The cowl 32′ of the second device 30′ comprises:
an upstream end section 32a′ located upstream of the heat exchange matrix 31′ of this second device 30′,
a section located at the external periphery of the heat exchange matrix 31′ of this second device 30′, and
a downstream end section 32c′ located downstream of the heat exchange matrix 31′ of this second device 30′.

It can be seen that each of the upstream end sections 27a′, 32a′ forms a divergent section, and that each of the downstream end sections 27e′, 32c′ forms a convergent.

In the example shown, the end sections 27a′, 27e′, 32a′, 32c′ each have a curved shape. The cowl 32′ of the second device 30′ has a predetermined diameter D3′ measured at the axial center of the heat exchange matrix 31′ of the second device 30′. In the example shown, D3′ is greater than D1′.

In FIG. 8:
H1′ represents the diameter at the free upstream end of the cowl 32′ or of the upstream end section 32a′ of this cowl 32′,
H2′ represents the diameter at the downstream end of the upstream end section 32a′ of this cowl 32′,
H3′ represents the diameter at the upstream end of the downstream end section 32c′ of this cowl 32′,
H4′ represents the diameter at the free downstream end of the cowl 32′ or of the downstream end section 32 c′ of this cowl 32′t,
H5′ represents the diameter at the free upstream end of the cowl 27′ or of the upstream end section 27a′ of this cowl 27′,
H6′ represents the diameter at the downstream end of the upstream end section 27a′ of this cowl 27′,
H7′ represents the diameter at the upstream end of the intermediate section 27c′,
H8′ represents the diameter at the downstream end of the intermediate section 27c′,
H9′ represents the diameter at the upstream end of the downstream end section 27e′ of this cowl 27′, and
H10′ represents the diameter at the free downstream end of the cowl or of the downstream end section 27e′ of this cowl 27′.

These diameters are measured in relation to the axis X.

In the example shown:
H1′ is less than or equal to H2′, H3 and H4′ in particular,
H5′ is less than H2′, H3′ and H6′ in particular,
H7′ is less than H8′, H3′ and H4′ in particular,
H2′ and H3′ are greater than H8′ and H9′.

Each of the devices 21′, 30′ may comprise a single heat exchanger, or may be sectorized and comprise two or more heat exchangers distributed around the axis X, as described above.

In the example shown, the device 21′ on the right of the drawing occupies a height h1′ in the duct of between 20 and 50% of the height hv1′ of the duct. The device 30′ on the left of the drawing occupies a height h2′ in the duct of between 10 and 30% of the height hv2′.

The heat exchange matrix 26′ of the first device 21′ has a height h3′ or radial dimension greater than or equal to that h4′ of the heat exchange matrix 31′ of the second device 30. The sum of the heights h3, h4 or radial dimensions of the heat exchange matrix 26′, 31′ of the first and second devices 21′, 30′ is less than the height hv1, hv2 or radial dimension of the duct V2 measured at the level of these devices 21′, 30′.

Alternatively, the heat exchange system 20 could comprise devices 21′, 30′ on the internal wall 23 side only.

It is understood that an external peripheral part of the air flow F2 flowing in the duct will be used in the devices 21, 30, as mentioned above. Among the rest of the air flow, an internal peripheral part will be used in the devices 21′, 30′, and will divide into a first, external peripheral part, which will penetrate the device 30′, and the rest, the internal peripheral part, which will penetrate the device 21′.

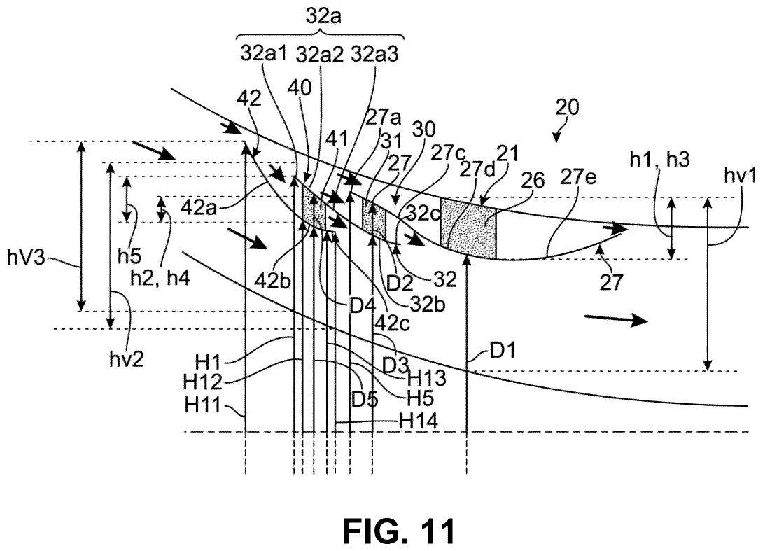

The fourth embodiment illustrated in FIG. 11 differs from the second embodiment in that the heat exchange system 20 comprises a third annular heat exchange device 40 which extends around the axis X and is located in the duct V2.

The system thus comprises:

The third device 40 comprises a heat exchange matrix 41 which is axially spaced from the heat exchange matrices 26, 31 of the devices 21, 30 and which is interposed between the cowl 32 of the second device 31 and another cowl 42 of the third device 40.

The cowl 32 of the second device has a predetermined diameter D3 measured at the axial center of the heat exchange matrix 31 of the second device 30, and a predetermined diameter D4 measured at the axial center of the heat exchange matrix 41 of the third device 40.

In the example shown, D4 is greater than D3.

The upstream end section 32a of the cowl 32 of the second device 30 is divided into several portions, including:
an upstream portion 32a1 located upstream of the heat exchange matrix 41 of the third device 40,
an intermediate portion 32a2 located at the external periphery of the heat exchange matrix 41 of this third device 40, and
a downstream portion 32a3 located downstream of the heat exchange matrix 41 of this third device 40.

The cowl 42 of the third device 40 comprises:
an upstream end section 42a located upstream of the heat exchange matrix 41 of this third device 40,
a section 42b located at the internal periphery of the heat exchange matrix 41 of this third device 40, and
a downstream end section 42c located downstream of the heat exchange matrix 41 of this third device 40.

It can be seen that sections and upstream end portions 27a, 32a1, and 42a form a divergent, and that the downstream end sections 27e, 32c, 42c form a convergent. In the example shown, the end sections and portions 27a, 32a1, 42a, 27e, 32c, 42c each have a curved shape.

The cowl 42 of the third device 40 has a predetermined diameter D5 measured at the axial center of the heat exchange matrix of the third device. In the example shown, D5 is greater than or equal to D1 and D3.

In FIG. 11:
H11 represents the diameter at the free upstream end of the cowl 42 or of the upstream end section 42a of this cowl 42,
H12 represents the diameter at the downstream end of the upstream end section 42a of this cowl 42,
H13 represents the diameter at the upstream end of the downstream end section 42c of this cowl 42,
H14 represents the diameter at the free downstream end of the cowl 42 or of the downstream end section 42c of this cowl 42.

These diameters are measured in relation to the axis X.

In the example shown:
H11 is greater than or equal to H12, H1 and H5 in particular, and could be the maximum diameter of the system 20.

Each of the devices 21, 30 may comprise a single heat exchanger, or may be sectorized and comprise two or more heat exchangers distributed around the axis X, as described above.

The heat exchange matrix 41 of the third device 40 has a height h5 or radial dimension less than or equal to that h4 of the heat exchange matrix 31 of the second device 30. The sum of the heights h3, h4, h5 or radial dimensions of heat exchange matrices 26, 31, 41 of devices 21, 30, 40 is less than or equal to the height hv1, hv2, hv3 or radial dimension of the duct measured at these devices 21, 30, 40.

It is understood that an external peripheral part of the air flow F2 flowing in the duct will be used in the devices 21, 30, 40 and that the rest of this flow will bypass the devices 21, 30, 40. The air used in the devices will divide into a first, internal peripheral part, which will penetrate the device 40, a middle part which will penetrate the device 30, and the remainder, the external peripheral part, which will penetrate the device 21.

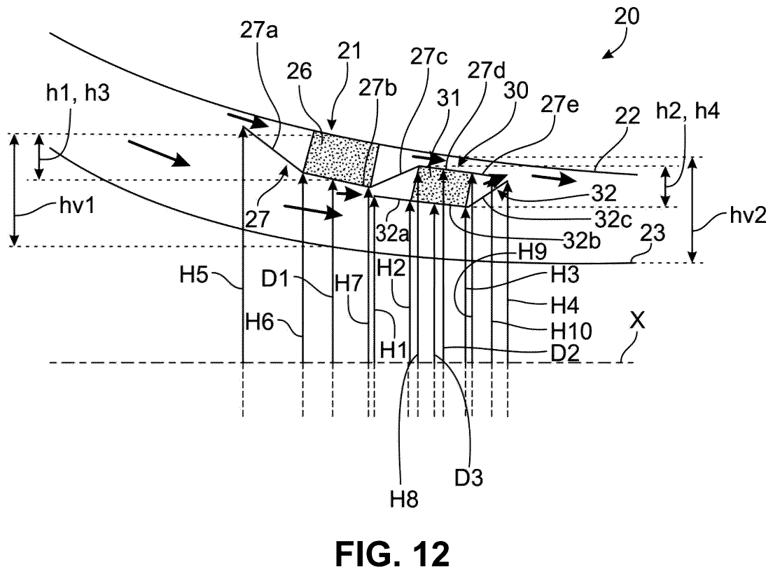

The fifth embodiment shown in FIG. 12 differs from the embodiment shown in FIG. 1 in that the second device 30 is located downstream rather than upstream of the first device 21.

The heat exchange matrix 26 of the device 21 is covered by the annular cowl 27 which extends axially, here downstream, to form an external cowl for the heat exchange matrix 31 of the device 30. This cowl 27 is thus located at the internal periphery of the heat exchange matrix 26 of the device 21 and at the external periphery of the heat exchange matrix 31 of the device 30. The heat exchange matrix 31 of the device 30 is also connected to the other cowl 32, which is therefore located at the internal periphery of this heat exchange matrix 31. The cowl 27 of the first device 21 comprises several successive axial sections along the axis X, namely:
an upstream end section 27a that is located upstream from the heat exchange matrix 26 of the first device 21,
a section 27b which extends to the internal periphery of the heat exchange matrix 26 of the first device 21,
an intermediate section 27c which extends axially between the heat exchange matrix 26 of the first device 21 and the heat exchange matrix 31 of the second device 32,
a section 27d which extends to the external periphery of the heat exchange matrix 31 of the second device 30, and
a downstream end section 27e located downstream of the heat exchange matrix 31 of the second device 30.

The cowl 32 of the second device 30 comprises:
an upstream end section 32a located upstream of the heat exchange matrix 31 of this second device 30,
a section 32b located at the internal periphery of the heat exchange matrix 31 of this second device 30, and
a downstream end section 32c located downstream of the heat exchange matrix 31 of this second device 30.

It can be seen that each of the upstream end sections 27a, 32a forms a divergent, and that each of the downstream end sections 27e, 32c forms a convergent.

In the example shown, the end sections 27a, 27e, 32a, 32c each have a frustoconical shape.

In the example shown, D3 is less than D1. D2 is greater than D1.

In FIG. 12:
H1 represents the diameter at the free upstream end of the cowl 32 or of the upstream end section 32a of this cowl 32,
H2 represents the diameter at the downstream end of the upstream end section 32a of this cowl 32,
H3 represents the diameter at the upstream end of the downstream end section 32c of this cowl 32,
H4 represents the diameter at the free downstream end of the cowl 32 or of the downstream end section 32c of this cowl 32,
H5 represents the diameter at the free upstream end of the cowl 27 or of the upstream end section 27a of this cowl 27,
H6 represents the diameter at the downstream end of the upstream end section 27a of this cowl 27,
H7 represents the diameter at the upstream end of the intermediate section 27c,
H8 represents the diameter at the downstream end of the intermediate section 27c,
H9 represents the diameter at the upstream end of the downstream end section 27e of this cowl 27, and
H10 represents the diameter at the free downstream end of the cowl 27 or of the downstream end section 27e of this cowl 27.

These diameters are measured in relation to the axis X.

In the example shown:
H1 is greater than or equal to H2, but less than H5 and H6 in particular,
H5 could be the maximum diameter of system 20,
H7 is lower than H8, H9 and H10 in particular
H2 and H3 are lower than H8 and H9.

Each of the devices 21, 30 may comprise a single heat exchanger, or may be sectorized and comprise two or more heat exchangers distributed around the axis X, as described above.

In the example shown, the device 21 located on the left in the drawing occupies a height h1 in the duct of between 20 and 50% of the height hv1 of this duct. The device 30 on the right of the drawing occupies a height h2 in the duct of between 10 and 30% of the height hv2.

The heat exchange matrix 26 of the first device 21 has a height h3 or radial dimension greater than or equal to that h4 of the heat exchange matrix 31 of the second device 30. The sum of the heights h3, h4 or radial dimensions of the heat exchange matrices 26, 31 of the first and second devices 21, 30 is less than the height hv1, hv2 or radial dimension of the duct V2 measured at these devices 21, 30.

It is understood that an external peripheral part of the air flow F2 flowing in the duct will be used in the device 21 and that the rest of this flow will bypass this device 21. Among this air flow which bypasses the device 21, a part of the external periphery will be taken and will penetrate the device 30, and the remainder will bypass this device 30.

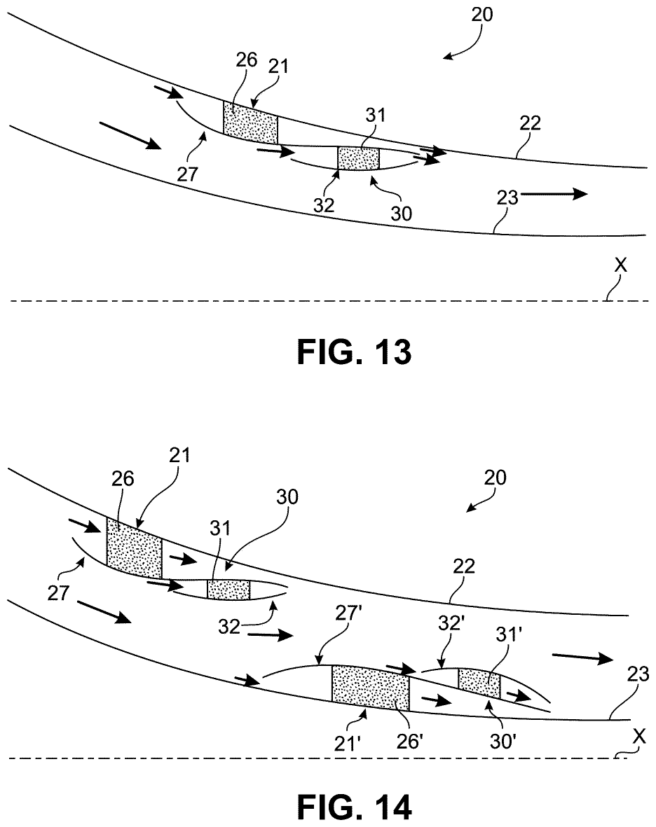

The sixth embodiment shown in FIG. 13 differs from the embodiment shown in FIG. 12 essentially in that the cowls 27, 32 are curved.

The system shown in FIG. 13 operates in a similar way to FIG. 12.

The embodiment shown in FIG. 14 is similar to that shown in FIG. 10, except that the second devices 30, 30′ are arranged downstream of the first devices 21, 21′ and are therefore of the type described with reference to FIGS. 12 and 13.

It is understood that an external peripheral part of the air flow F2 flowing in the duct will be used in the devices 21, 30, as mentioned above. Among the rest of the air flow, an internal peripheral part will be used in the devices 21′, 30′, and will divide into a first, internal peripheral part, which will penetrate the device 21′, and another internal peripheral part of the air flow which bypasses the device 21′, which will enter the device 30′.

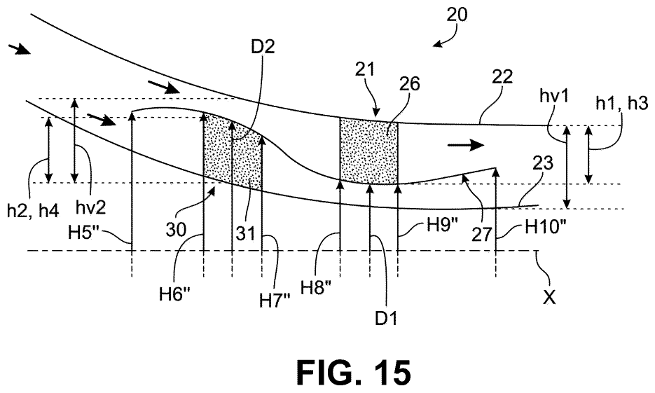

In the embodiment shown in FIG. 15, the devices 21 and 30 are supported by the external wall 22 and internal wall 23 respectively.

The first device 21 is similar to that described above in relation to FIGS. 1 and 2, for example.

The second device 30 is located upstream of the first device 21 and comprises a heat exchange matrix 31 which is axially spaced from the heat exchange matrix 26 of the first device 21 and which is interposed between the cowl 27 of the first device 21 and the wall 23.

It is therefore understood that your devices 21, 30 share the same cowl 27 and that there are no other cowls in the system 20 insofar as the heat exchange matrix 26 of the first device 21 extends between the cowl 27 and the external wall 22, and the heat exchange matrix 31 of the second device 30 extends between the cowl 27 and the internal wall 23.

The cowl 27 comprises:
an upstream end section 27a which is located upstream of the heat exchange matrix 31 of the second device 30 and which forms a divergent,
a section 27b which extends to the external periphery of the exchange matrix 31 of the second device 30,
an intermediate section 27c which extends axially between the heat exchange matrix 31 of the second device 30 and the heat exchange matrix 26 of the first device 21,
a section 27d which extends to the internal periphery of the exchange matrix 26 of the first device 21, and
a downstream end section 27e which forms a convergent and is located downstream of the heat exchange matrix 26 of the first device 21.

In FIG. 15:
H5″ represents the diameter at the free upstream end of the cowl 27 or of the upstream end section 27a of this cowl 27,
H6″ represents the diameter at the downstream end of the upstream end section 27a of this cowl 27,
H7″ represents the diameter at the upstream end of the intermediate section 27c,
H8″ represents the diameter at the downstream end of the intermediate section 27c,
H9″ represents the diameter at the upstream end of the downstream end section 27e of this cowl 27, and
H10″ represents the diameter at the free downstream end of the cowl 27 or of the downstream end section 27e of this cowl 27.

These diameters are measured in relation to the axis X.

In the example shown:
H5″ is greater than H6″ in particular,
H7″ is greater than H8 in particular.

Each of the devices 21, 30 may comprise a single heat exchanger, or may be sectorized and comprise two or more heat exchangers distributed around the axis X, as described above.

In the example shown, the device 21 located on the right of the drawing occupies a height h1 in the duct of between 50 and 80% of the height hv1 of this duct.

The device 30 on the left of the drawing occupies a height h2 in the duct of between 50 and 80% of the height hv2.

The heat exchange matrix 26 of the first device 21 has a height h2 or radial dimension greater than or equal to that h4 of the heat exchange matrix 32 of the second device 30. The sum of the heights h2, h4 or radial dimensions of the heat exchange matrices 26, 31 of the first and second devices 21, 30 is greater than the height hv1, hv2 or radial dimension of the duct measured at these devices 21, 30.

It is understood that an internal peripheral part of the air flow F2 flowing in the duct will enter the device 30 while the rest of the air flow will penetrate the device 21. The entire air flow is therefore used to exchange heat.

Installing these devices partially superimposed with an axial offset limits both the axial and radial space occupied by the devices. By limiting the radial footprint, it is possible to achieve higher deceleration ratios within each of the devices.

1. A turbine engine for an aircraft having a heat exchange system, the system comprising:
two annular walls, external and internal respectively, which extend around each other and around a same axis (X), and which are configured to define between them a flow duct (V2) for a gas flow (F2),
a first annular heat exchange device which extends around the axis (X) and is carried by one of said walls, and which is located in the duct (V2), the first device comprising a heat exchange matrix interposed between the wall and a cowl which has a predetermined diameter D1 measured at the axial center of the heat exchange matrix of the first device,
a second annular heat exchange device which extends around the axis (X) and is located in the duct (V2), the second device comprising a heat exchange matrix which is axially spaced from the heat exchange matrix of the first device and which is interposed between the cowl of the first device and the opposite wall or another cowl of the second device, the cowl of the first device having a predetermined diameter D2 measured at the axial center of the heat exchange matrix of the second device,
wherein D2 is greater than D1 when the first device is carried by the external wall, or
D2 is less than D1 when the first device is carried by the internal wall.

2. The turbine engine according to claim 1, wherein the cowl of the first device comprises several successive axial sections along the axis (X):
an upstream end section which is located upstream of the heat exchange matrix of the second device, a section which extends at the periphery of the heat exchange matrix of the second device, an intermediate section which extends axially between the heat exchange matrix of the second device and the heat exchange matrix of the first device, a section which extends at the periphery of the heat exchange matrix of the first device, and a downstream end section which is located downstream of the heat exchange matrix of the first device, or
an upstream end section extending upstream of the heat exchange matrix of the first device, a section which extends at the periphery of the heat exchange matrix of the first device, an intermediate section which extends axially between the heat exchange matrix of the first device and the heat exchange matrix of the second device, a section which extends at the periphery of the heat exchange matrix of the second device, and a downstream end section which is located downstream of the heat exchange matrix of the second device.

3. The turbine engine according to claim 2, wherein the second device further comprises said further cowl which comprises an upstream end section located upstream of the heat exchange matrix of that second device, a section located at the periphery of the heat exchange matrix of that second device, and a downstream end section located downstream of the heat exchange matrix of that second device.

4. The turbine engine according to claim 1, wherein the second device further comprises said other cowl which has a predetermined diameter D3 measured at the axial center of the heat exchange matrix of the second device,
wherein D3 is greater than D1 when the first device is carried by the external wall, or
D3 is less than D1 when the first device is carried by the internal wall.

5. The turbine engine according to claim 1, further comprising:
a third annular heat exchange device of the surface type which extends around the axis (X) and is located in the duct (V2), the third device comprising a heat exchange matrix which is axially spaced from the heat exchange matrix of the first and second devices and which is interposed between the cowl of the second device and the other of the walls or a further cowl of the third device, the second device comprising said further cowl which has a predetermined diameter D3 measured at the axial center of the heat exchange matrix of the second device, and a predetermined diameter D4 measured at the axial center of the heat exchange matrix of the third device,
wherein D4 is greater than D3 when the first device is carried by the external wall, or
D4 is less than D3 when the first device is carried by the internal wall.

6. The turbine engine according to claim 5, wherein the third device further comprises said further cowl which comprises an upstream end section located upstream of the heat exchange matrix of the third device, a section located at the periphery of the heat exchange matrix of the third device, and a downstream end section located downstream of the heat exchange matrix of said third device.

7. The turbine engine according to claim 2, wherein said or each upstream end section forms a divergent, and said or each downstream end section forms a convergent.

8. The turbine engine according to claim 2, wherein the end sections have a frustoconical or rounded shape.

9. The turbine engine according to claim 1, wherein the heat exchange matrix of the first device has a height (h3) or radial dimension greater than or equal to that (h4) of the heat exchange matrix of the second device.

10. The turbine engine according claim 1, wherein a sum of heights (h3, h4) or radial dimensions of the heat exchange matrix of the first and second devices is less than a height (hv1, hv2) or radial dimension of the duct (V2) measured at a level of these devices

11. The turbine engine according to claim 1, wherein a sum heights (h3, h4) or radial dimensions of the heat exchange matrix of the first and second devices is greater than a height (hv1, hv2) or radial dimension of the duct measured at a level of these devices

12. The turbine engine according to claim 1, wherein each of the external and internal walls carries said first heat exchange device, which is associated with said second heat exchange device or even said third heat exchange device.
